(19) United States
(12) Patent Application Publication
(10) Pub. No.: US 2025/0041971 A1
(43) Pub. Date: Feb. 6, 2025

(54) LOCALIZED MULTIPLE BEAMED LASER PEENING OF CONNECTING ROD

(71) Applicant: GM Global Technology Operations LLC, Detroit, MI (US)

(72) Inventors: Jianghuai Yang, Rochester Hills, MI (US); Ronald J. Helmstadt, Bridgeport, MI (US); Qigui Wang, Rochester Hills, MI (US); Richard D. Ricchi, Lapeer, MI (US)

(21) Appl. No.: 18/362,111

(22) Filed: Jul. 31, 2023

(51) Int. Cl. B23K 26/356; B23K 26/00; B23K 26/0622; B23K 26/067; C21D 7/06; C23C 28/00; F16J 1/12

(52) U.S. Cl. CPC B23K 26/356; B23K 26/0093; B23K 26/0622; B23K 26/0676; C21D 7/06; C23C 28/00; F16J 1/12; B23K 2101/34

(57) ABSTRACT

A connecting rod for a vehicle and a method of laser peening a connecting rod. The connecting rod defines a pin opening at a first end and a cylindrical bore at a second end. A clear coating is applied on a first target surface and a second target surface of the connecting rod. The first and second opposing target surfaces are impinged in a localized area between the pin opening and the cylindrical bore with a plurality of pulses of pulsed laser beams. After laser peening, the localized area between the pin opening and the cylindrical bore exhibits compressive residual stresses at a depth of up to 0.75 millimeters.

### BACKGROUND

Connecting rods are used in internal combustion engines as well as steam engines to convert linear movement of the engine pistons to the rotational movement of a crankshaft. To facilitate rotational movement, connecting rods are often connected to pistons using a pin at one end, which allows rotational movement of the connecting rod relative to the piston. The piston moves up and down inside a cylindrical bore during internal combustion process. The other end of the connecting rod links to the crankshaft which also allows rotational movement of the crankshaft relative to the connecting rod. The repetitive motion of the pistons and rotational movement of the crankshaft imparts repetitive forces on connecting rods, including shear forces, compression forces, and tensile forces.

Connecting rods are commonly formed from steel but other materials such as aluminum and titanium may be used in applications. In addition, connecting rods are often machined out of solid billets. They may also be formed by powder metallurgy and forging. To alleviate some of the stresses imparted by the machining process, connecting rods may be treated using various heat and surface treatment processes, including, for example, shot peening and austempering heat treatment.

While current connecting rods and surface treatments achieve their intended purpose, room remains for development of surface treatments to improve connecting rod performance.

### SUMMARY

According to various aspects, the present disclosure is directed to a method of laser peening a connecting rod for a vehicle. The connecting rod defines a pin opening at a first end and a cylindrical bore at a second end. The method includes applying a clear coating on a first target surface and a second target surface of the connecting rod. The method further includes impinging the first target surface in a localized area between the pin opening and the cylindrical bore with a first plurality of pulses of a first pulsed laser beam and impinging the second target surface in the localized area with a second plurality of pulses of a second pulsed laser beam, wherein the second target surface opposes the first target surface and the first plurality of pulses and the second plurality of pulses are emitted at the same time. The method further includes applying a compressive residual stress to the first target surface and the second target surface at a depth of up to 0.75 millimeters.

In embodiments of the above, the method includes applying water as the clear coating.

In any of the above embodiments, the method includes applying an overlay to the first target surface and the second target surface prior to applying the water. The overlay is opaque to the first pulsed laser beam and the second pulsed laser beam. In further embodiments, the overlay includes black paint and the method includes applying black paint as the overlay.

In any of the above embodiments, the method includes impinging a first center axis of the first pulsed laser beam perpendicular to the first target surface, and impinging a second center axis of the second pulsed laser beam perpendicular to the second target surface. In further embodiments, the first center axis and the second center axis are coaxial.

Alternatively, in embodiments, the first center axis and the second center axis are offset along a length of the connecting rod. Alternatively, in any of the above embodiments, the method includes impinging a first center axis of the first pulsed laser beam at an angle in the range of greater than 0 degrees to 30 degrees from perpendicular to the first target surface; and impinging a second center axis of the second pulsed laser beam at an angle in the range of greater than 0 degrees to 30 degrees from perpendicular to the second target surface. In further embodiments, the first center axis and second center axis are coaxial. In alternative further embodiments the first center axis is at an angle up to 10 degrees from the second center axis.

In any of the above embodiments, a pulse of the first pulsed laser beam exhibits a first spot area on the first target surface and a plurality of the first spot areas of a plurality of the pulses of the pulsed laser beam overlap in the range of between 30 percent and 40 percent of the total spot area of the plurality of the spots.

In any of the above embodiments, the method further includes impinging the first target surface with a third pulsed laser beam; and impinging the second target surface with a fourth pulsed laser beam.

In any of the above embodiments, the method includes machining at least one of a side slot and fastener threads in the connecting rod prior to impinging the first and second target surfaces with the first pulsed laser beam and second pulsed laser beam.

In any of the above embodiments, the method further includes modeling the connecting rod and performing stress simulations to determine the localized area to impinge the connecting rod with the first plurality of pulses of the first pulsed laser beam and the second plurality of pulses of the second pulsed laser beam.

Accordingly to various additional embodiments, the present disclosure relates to a method of cold working a connecting rod for a vehicle. The connecting rod defines a pin opening at a first end and a cylindrical bore at a second end. The method includes emitting from at least one laser source a first plurality of pulses of a first pulsed laser beam and a second plurality of pulses of a second pulsed laser beam. The method further includes impinging a first target surface in a localized area of a connecting rod including a clear coating with the first plurality of pulses. The localized area is between the pin opening and the cylindrical bore. The method also includes impinging a second target surface of the connecting rod including the clear coating with the second plurality of pulses. The second target surface opposes the first target surface and the pulses of the first pulsed laser beam and the second pulsed laser beam are emitted at the same time. The method yet further includes evaporating a portion of the first target surface and generating a first plasma and evaporating a portion of the second target surface and generating a second plasma, trapping the first plasma between the clear coating and the first target surface and trapping the second plasma between the clear coating and the second target surface, expanding the first plasma and creating a first shockwave and expanding the second plasma and the second shockwave, and forming a first compressive residual stress at the first target surface in the range of 500 Megapascals (MPa) to 1000 MPa and a second compressive residual stress at the second target surface in the range of 500 Megapascals (MPa) to 1000 MPa. The first and second compressive residual stresses are at a depth of up to 0.75 millimeters.

In embodiments of the above, the clear coating includes a layer of water.

In any of the above embodiments, evaporating a portion of the first target surface includes evaporating a portion of an overlay on the first target surface, and evaporating a portion of the second target surface includes evaporating a portion of the overlay on the second target surface. In further embodiments, the overlay comprises black paint.

In any of the above embodiments, a first center axis of the first pulsed laser beam impinges the first target surface at an angle in the range of than 0 degrees to 30 degrees from perpendicular to the first target surface, and a second center axis of the second pulsed laser beam impinges the second target surface at an angle in the range of 0 degrees to 30 degrees from perpendicular to the second target surface.

According to various further aspects, the present disclosure is directed to a connecting rod for a vehicle. The connecting rod defines a pin opening at a first end and a cylindrical bore at a second end. The connecting rod includes an overlay present on a surface of the connecting rod. In addition, the connecting rod includes a localized area between the pin opening and the cylindrical bore, wherein a portion of the overlay is removed in the localized area and wherein the localized area exhibits compressive residual stresses in the range of 500 Megapascals (MPa) to 1000 MPa at a depth of up to 0.75 millimeters.

### BRIEF DESCRIPTION OF DRAWINGS

The drawings described herein are for illustration purposes only and are not intended to limit the scope of the present disclosure in any way.

FIG. 1 illustrates an embodiment of a vehicle including a connecting rod according to embodiments of the present disclosure.

FIG. 2 illustrates a process for laser peening a connecting rod according to embodiments of the present disclosure.

FIG. 3A illustrates an embodiment of a connecting rod according to embodiments of the present disclosure.

FIG. 3B illustrates an embodiment of a connecting rod according to embodiments of the present disclosure including a machined side slot.

FIG. 4A illustrates a diagram of pulsed laser beams incident on target surfaces of a connecting rod according to embodiments of the present disclosure.

FIG. 4B illustrates pulsed laser beams incident on target surfaces of a connecting rod according to embodiments of the present disclosure.

FIG. 5A illustrates a square laser beam pulse spot according to embodiments of the present disclosure.

FIG. 5B illustrates a rectangular laser beam pulse spot according to embodiments of the present disclosure.

FIG. 5C illustrates overlapping laser beam pulse spots incident on a target surface according to embodiments of the present disclosure.

FIG. 6 illustrates a system for laser peening a connecting rod according to embodiments of the present disclosure.

### DETAILED DESCRIPTION

The following description is merely exemplary in nature and is not intended to limit the present disclosure, application, or uses. Furthermore, there is no intention to be bound by any expressed or implied theory presented in the preceding introduction, summary, or the following detailed description. It should be understood that throughout the drawings, corresponding reference numerals indicate like or corresponding parts and features.

In the claims and specification, certain elements are designated as “first,” “second,” “third,” “fourth,” “fifth,” “sixth,” and “seventh.” These are arbitrary designations intended to be consistent only in the section in which they appear, i.e. the specification or the claims or the summary, and are not necessarily consistent between the specification, the claims, and the summary. In that sense they are not intended to limit the elements in any way and a “second” element labeled as such in the claim may or may not refer to a “second” element labeled as such in the specification. Instead, the elements are distinguishable by their disposition, description, connections, and function.

As used herein, the term “vehicle” is not limited to automobiles. While the present technology is described primarily herein in connection with connecting rods used in conjunction with internal combustion engines and vehicles. The concepts can be used in a wide variety of applications, such as in connection with components used in motorcycles, mopeds, locomotives, aircraft, marine craft, and other vehicles, as well as in other applications incorporating hydrogen fuel cells and in applications incorporating electric motors. Applications include, for example, components industrial machines and motors, agricultural equipment, compressors, defense equipment, HVAC (heating, ventilation, and air conditioning) systems, residential and commercial power generators, and pumps.

Reference will now be made in detail to several examples of the disclosure that are illustrated in accompanying drawings. Whenever possible, the same or similar reference numerals are used in the drawings and the description to refer to the same or like parts or steps. The drawings are in simplified form and are not to precise scale.

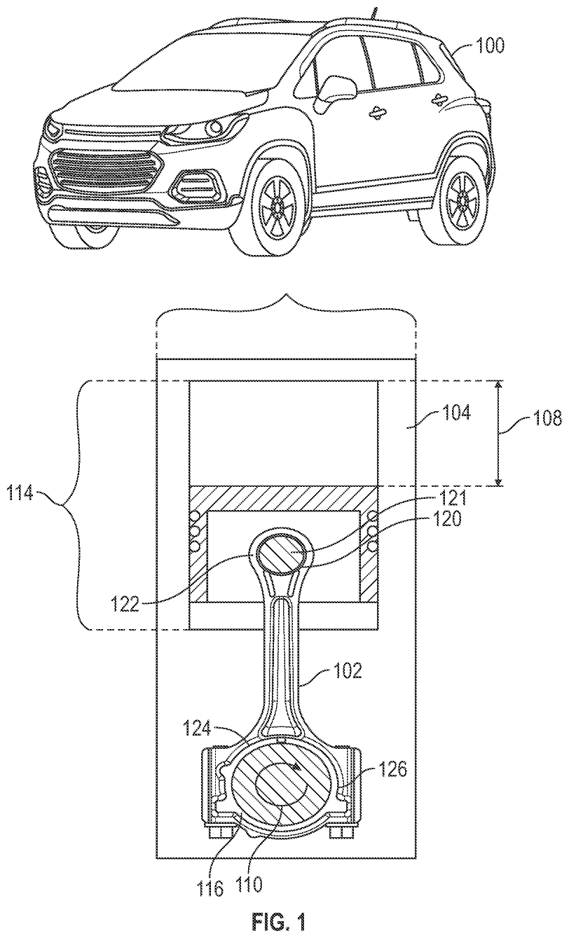

The present disclosure relates to methods of surface treating a connecting rod with localized, multiple beam laser peening. The laser peening imparts compressive residual stresses in a range of 500 megapascals (MPa) to 1100 MPa, including all values and ranges therein, up to a depth of 0.75 millimeters from the surfaces that are laser peened. As previously noted, and with reference to FIG. 1, connecting rods 102 are used in vehicle 100 internal combustion engines 104 to convert the linear, reciprocating movement 108 of the engine pistons 112 within the combustion chambers 114 to the rotational movement 110 of the crankshaft 116. To facilitate rotational movement, each connecting rod 102 is often connected to a piston 112 by a pin opening 120 defined in at a first end 122 of the connecting rod 102, in which a pin 121 is inserted allowing rotational movement of the connecting rod 102 relative to the piston 112. The other end 124 of the connecting rod 102 includes a cylindrical bore 126 in which the crankshaft 116 is inserted, which also allows rotational movement of the crankshaft 116 relative to the connecting rod 102. The repetitive motion of the piston 112 and rotational movement of the crankshaft 116 imparts repetitive forces on the connecting rod 102, including shear forces, compression forces, and tensile forces.

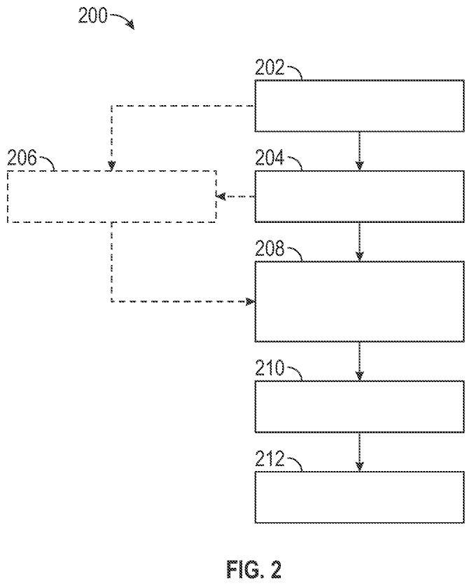

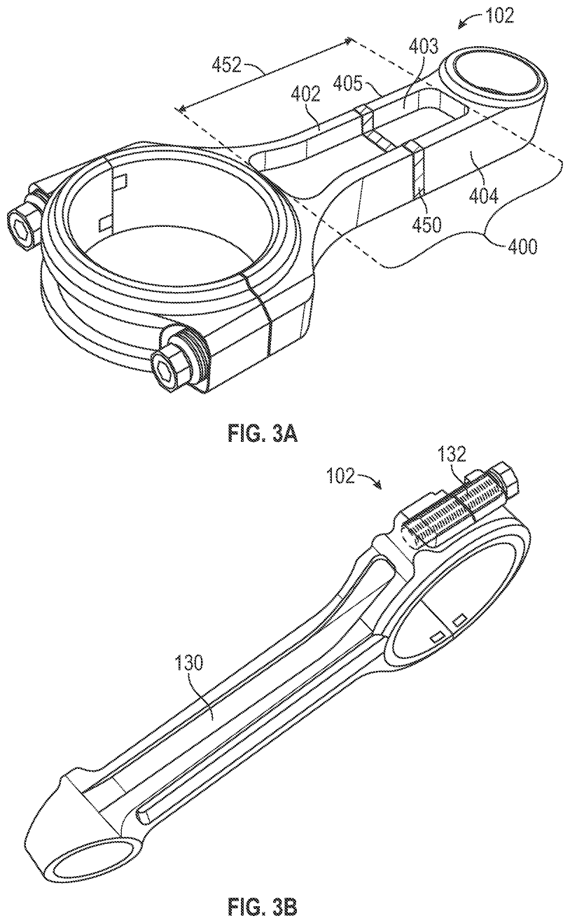

FIG. 2 illustrates an embodiment of a method 200 for laser peening a connecting rod 102, illustrated in FIG. 3A. At block 202, a connecting rod 102 is formed. In embodiments, the connecting rod 102 is forged from steel such as SAE 1050 or 1075 steel, micro-alloyed steels including manganese, silicon, vanadium and sulfur alloying elements, such as 46 MnSiVS 4, 5, 6 series including carbon present in the range of 0.42 to 0.48 percent by weight and sulfur present from 0.04 percent by weight to 0.06 percent by weight. In alternative embodiments, the connecting rod 102 is formed from cast steel or iron such as austempered ductile cast iron (ADI), titanium, aluminum, or a metal matrix composite (MMC) and may alternatively be machined out of solid billets, forged, formed from powder metal, or formed using an additive manufacturing process such as direct metal laser sintering or directed energy deposition, using any of the materials noted above. A metal matrix composite is understood as a composite material including fibers or particles dispersed in a metallic matrix, such as copper, aluminum, or steel. The fibers or particles may be ceramics such as alumina or silicon carbide, or another metal. The connecting rod 102 may also be surface treated, such as by carburizing and hardening, austempering, converting ductile iron into austempered ductile iron.

At block 204, the connecting rod 102 is optionally cleaned using shot blast cleaning, with shot formed from, for example, steel, iron, ceramic or sand. In addition, before or after shot blast cleaning, oil and grease may be removed using solvents or detergents. At block 206, the connecting rod 102 is optionally machined, at least partially, to form various features, including at least one of side slots 130 and mechanical fastener threads 132 as illustrated in FIG. 3B. In embodiments, block 204 is omitted altogether, and the process moves from block 202 to 206 to allow for easier machining at block 206.

At block 208 and with reference again to FIG. 3A, the connecting rod 102 is laser peened in localized areas 400 using at least two pulsed laser beams that impinge on opposing surfaces 402, 404 of the connecting rod 102. Opposing surfaces are understood as surfaces on the connecting rod 102 that are opposite from each other relative to the connecting rod 102 as a whole or a feature of the connecting rod 102. For example, 402 and 404 are opposing surfaces, 402 and 403 are also opposing surfaces of the slot wall 405. The localized areas include the target surfaces 402, 404 between the pin opening 120 and the cylindrical bore 126. In embodiments, laser peening is performed only in localized areas to prevent the need to mask features already machined into the connecting rod 102.

Laser peening, also referred to as laser shock peening, is understood as a cold working process that imparts compressive residual stresses in the surface of a work piece, i.e., the connecting rod 102. In addition, a cold working process is understood as any metal working process in which the metal is plastically deformed below its recrystallization temperature. It should be appreciated that the localized areas 400 where laser peening is applied to the connecting rod 102 may be previously identified through computer modeling and stress simulations as being regions that exhibit relatively higher stresses during use. In additional embodiments, the laser peening may be varied in the localized areas identified by the computer modeling simulating the highest, or relatively higher, stresses applied to the connecting rod during use as compared to the other stresses applied to the connecting rod during use. For the connecting rod 102 this is, in embodiments, limited to the shank region/I-beam region illustrated in FIG. 3A. Further, it is not necessary to mask other regions of the connecting rod 102 during the laser peening process and, therefore, the process is performed without masking.

Returning again to FIG. 2, at block 210, the connecting rod 102 may be inspected for defects or other manufacturing issues. At block 212, finish machining is performed to form any remaining threads, bores, or other features. Further, polishing may also be performed to smooth the surfaces of the connecting rod 102.

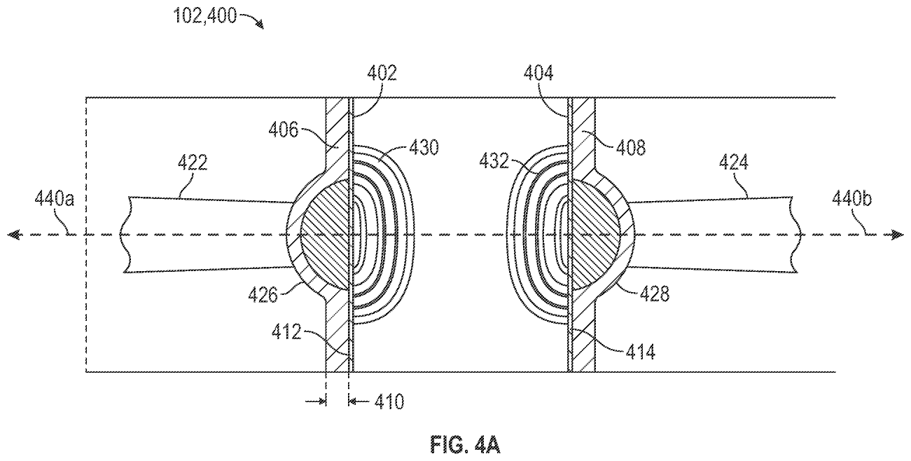

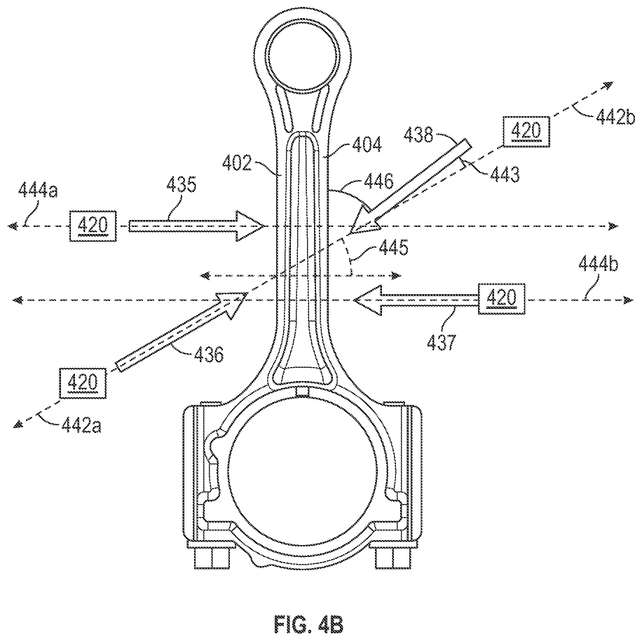

Reference is now made to FIG. 4A illustrating a pulse from each of a pair of pulsed laser beams 422, 424 impinging on opposing target surfaces 402, 404 of the connecting rod 102. To facilitate laser peening at block 208 of FIG. 2, the target surfaces 402, 404, i.e., the surfaces to be laser peened, are covered with a clear coating 406, 408, such as a layer of water. The water may be delivered by a water jet affixed to the laser source 420 (see FIG. 4B). The water layer 406, 408 may have a thickness 410 in the range of 1 mm to 100 mm, including all values and ranges therein. In alternative embodiments, other clear coatings may be used, such as clear polymer coatings or glass coatings, or clear tape. The clear coatings 406, 408 are transparent to the pulses of the pulsed laser beams 422, 424, allowing at least 50 percent of incident electromagnetic energy emitted by the laser source 420 (see FIG. 4B) to pass through the water, or other clear coating, including all values and ranges from 50 percent to 100 percent.

In addition, in further embodiments, the target surfaces 402, 404 are covered in an overlay 412, 414 opaque to the pulses of the pulsed laser beams 422, 424. The overlay 412 414 is understood as an overlay that absorbs at least 50 percent of incident electromagnetic energy emitted by the laser source 420 (see FIG. 4B), including all values and ranges from 50 percent to 100 percent. In embodiments, the overlay 412, 414 includes at least one of black paint, black tape, aluminum tape, or another absorptive coating. In further embodiments, the target surfaces 402, 404 may be surface treated with a black oxide coating.

When a laser source 420 emits a plurality of pulses form a pulsed laser beam 422, 424, electromagnetic energy in a given wavelength, or wavelengths, passes through the clear coating 406, 408 and impinges the overlay 412, 414 or the bare target surfaces 402, 404 if an overlay is not present. Each pulse causes a portion of the overlay 412, 414 or the bare target surface 402, 404 to vaporize. The vapor then becomes trapped between the clear coating 406, 408 and the target surface 402, 404. Continued pulses of the laser beams 422, 424 cause additional vaporization and ionization of the vapor creating an expanding plasma 426, 428. The expansion of the plasma 426, 428 with the pulses creates shock waves 430, 432 in the connecting rod 102 resulting in the formation of compressive residual stresses at the target surfaces 402, 404 and beneath the target surfaces 402, 404 up to 0.75 millimeters (mm) in depth. The compressive residual stresses may be determined by calculating the compressive residual stress from X-ray diffraction measurements (such as determined by ASTM E915) or by the Almen strip test (such as determined by SAE J433).

In embodiments, one or more laser sources 420, illustrated in FIGS. 4A and 4B, emits electromagnetic energy exhibiting one or more wavelengths in the range of 532 nanometers (nm) to 1054 nm, including all values and ranges therein. In additional embodiments, the laser source(s) 420, includes a neodymium-doped glass laser such as a neodymium-doped yttrium aluminum garnet laser. The laser source(s) 420 delivers a plurality of pulses of each laser beam 422, 424. In embodiments, each pulsed laser beam 422, 424 has a power density in the range of 2 gigawatts per square centimeter (GW/cm\hat{ }2) to 5 GW/cm\hat{ }2, including all values and ranges therein. Further, the duration of each pulse is in the range of 5 nanoseconds (ns) to 20 nanoseconds, including all values and ranges therein. The frequency of the pulses is in the range of 0.6 Kilohertz (kHz) to 1.5 kHz, including all values and ranges therein. The pulses are emitted from the laser source(s) 420 of opposing pulsed laser beams 422, 424 generally at the same time, such that at least a portion of a given pulse of each pulsed laser beam 422, 424 overlap.

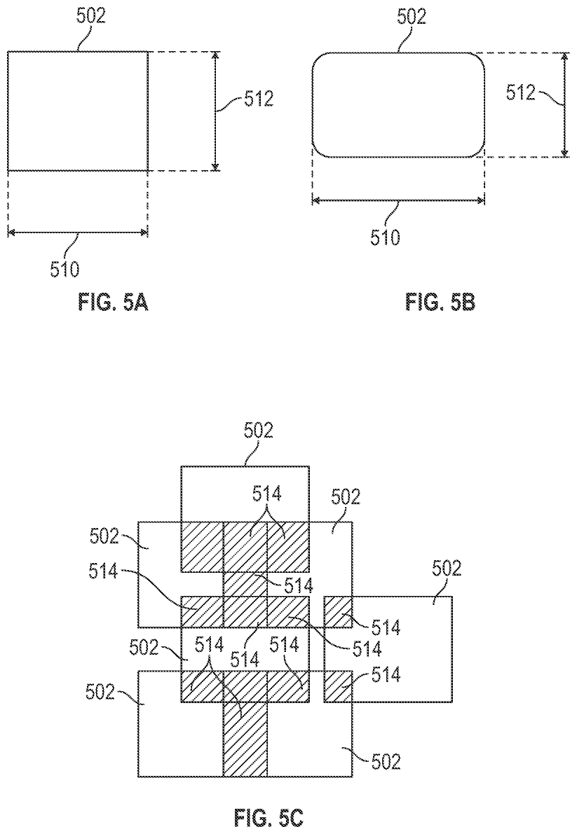

As illustrated in FIGS. 5A and 5B, in embodiments, the pulses of the pulsed laser beams 422, 424, 436, 438 incident on the target surfaces 402, 404 exhibit a spot 502 where they impinge on the target surfaces 402, 404. The area of the pulse spots 502 of the pulsed laser beams 422, 424 incident on the target surfaces 402, 404 exhibits a height 510 in the range of 1 mm to 2.5 mm, including all values and ranges therein, and a width 512 in the range of 1 mm to 2.5 mm, including all values and ranges therein. As illustrated in FIGS. 5A and 5B, the shape of the spot 502 and spot area defined by the spot 502 is rectangular or square. It should be appreciated that other shapes may be used as well, such as circular, elliptical, etc. Further, the pulse density of the pulsed laser beams 422, 424 is in the range of 700 pulses per square centimeter (pulses/cm\hat{ }2) to 1000 pulses/cm\hat{ }2, including all values and ranges therein. As illustrated in FIG. 5C, the spots 502 of multiple pulses from each pulse laser beam 422, 424 may exhibit an overlap 514 of 30 percent to 40 percent of the total spot area of the plurality of spots 502. The pulses form the pulsed laser beams 422, 424 impart compressive residual stresses in the target surfaces 402, 404 and at depths of 0.20 up to 0.75 millimeters (mm) from the target surface 402, 404, including all values and ranges therein. Further, the compressive residual stresses may range from 500 megapascals (MPa) to 1100 MPa, including all values and ranges therein, in 1050 or 1075 steel, for example, wherein relatively higher compressive residual stresses are present near the surface of the steel.

Referring again to FIGS. 4A and 4B, multiple beam laser peening utilizes at least one opposing pair of pulsed laser beams 422, 424, such as illustrated in FIG. 4A. Without being bound to any particular theory, use of opposing pulsed laser beam 422, 424, 435, 436, 437, 438, is understood to assist in preventing distortion of the connecting rod 102 during the laser peening process. As illustrated in FIG. 4B, two pairs of opposing pulsed laser beams 435, 436, 437, 438 are incident on opposing target surfaces 402, 404 of the connecting rod 102. For example, a first pair of opposing pulsed laser beams may include a first pulsed laser beam 435 impinges on a first target surface 402 opposing a second pulsed laser beam 437, which impinges on a second target surface 404. A second pair of opposing pulsed laser beams may include a third pulsed laser beam 436 impinges on the first target surface 402 opposing a second pulsed laser beam 438, which impinges on the second target surface 404. As illustrated, the pulsed laser beams 435, 436, 437, 438 are emitted by individual laser sources 420. However, it may be appreciated, when utilizing light guides, pulses from more than on pulsed laser beams 435, 436, 437, 438 may be generated by a single laser source 420 and, in further embodiments, all of the pulsed laser beams 422, 424, 436, 438 may be emitted by a single light source 420. The angle of incidence and degree of offset between the axes of the pulsed laser beams 435, 436, 437, 438 are selected to provide a relatively uniform temperature and minimize the tensile residual stress beneath the surface of the connecting rod, which may cause the connecting rod to deform.

Referring back to FIG. 4A, this figure illustrates a first pair of opposing pulsed laser beams 422, 424 impinging on the first target surface 402 and the second target surface 404. The center axis 440a, 440b of the pulsed laser beams 422, 424 are coaxial, where the center axes 440a, 440b overlap. The center axis of each pulsed laser beam may be understood as the optical axis, an imaginary line that defines the path along which the emitted electromagnetic energy propagates and is an average center point, or geometrical center within the physical perimeter of the pulsed laser beam (spot). For a cylindrical beam, the center axis is the center of the cylinder. For a square beam, the center axis is the center of the square. Alternatively, as illustrated in FIG. 4B, the center axes 444a, 444b of the pulsed laser beams 435, 437 may be offset along the length 452 (see FIG. 3A) of the connecting rod 102 and parallel to each other. And in additional alternative embodiments, the center axes 442a, 442b may deviate from being coaxial up to an angle 443 of 10 degrees, including all values and ranges greater than 0 degrees to 10 degrees. The center axes 440a, 440b of the pulsed laser beams 422, 424 illustrated in FIG. 4A and the center axes 444a, 444b of the pulsed laser beams 435, 437 illustrated in FIG. 4B are perpendicular (i.e., 90 degrees) to the target surfaces 402, 404. In additional or alternative embodiments, only one of the center axes, a first center axis, may be perpendicular and the other center axis, second center axis, may be arranged at an angle of up to ten degrees relative to the first center axis. In yet additional or alternative embodiments, the center axes 442a, 442b of the pulsed laser beams 436, 438 illustrated in FIG. 4B may deviate from being perpendicular to the target surfaces 402, 404 at an angle 445 in the range of 0.1 degree to 30 degrees from perpendicular, including all values and ranges therein. Correspondingly, the pulsed laser beams 436, 438 may be arranged at an angle 446 to the target surfaces 402, 404 in the range of 0.1 degree to 70 degrees, including all values and ranges therein. As with the pulsed laser beams 422, 424, 435, 437 that are perpendicular to the target surfaces 402, 404, the pulsed laser beams 436, 438 at an angle from perpendicular to the target surfacer 402, 404 have coaxial axes 442a, 442b that may deviate 10 degrees from being coaxial. While two pairs of pulsed laser beams 435, 436, 437, 438 are illustrated in FIG. 4B, more than two pairs may also be present, such as up to 10 pairs. In further embodiments, the pulses of a pulsed laser beam may be incident around the entire perimeter of the connect rod 102 at a given location 450 along the length 452 of the target surface 402, 404 as illustrated in FIG. 3A.

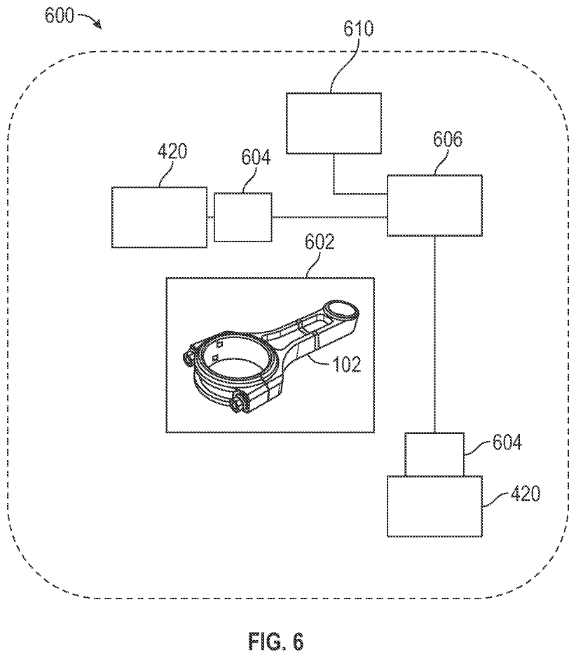

FIG. 6 illustrates a system 600 for laser peening a connecting rod 102. The system 600 generally includes a fixture 602 for holding the connecting rod 102. The system 600 also includes at least one laser source 420. Further, for each laser source 420, the system includes a water supply 604 that is used to applying a layer of water on the surface of the connecting rod. As illustrated, in embodiments, the water supply 604 may be affixed to the laser source 420 or may be a separate component from the laser source 420. Furthermore, a power supply 606 is provided for each laser source 420 to deliver the pulsed laser beams. The system may further include a milling head 610 controlled by computer numerical control for machining features on the connecting rod.

The methods and connecting rods formed herein offer a number of advantages. These advantages include reducing debris and contaminants created during shot peening. These advantages also include a reduction in shot peening particles that may be embedded in the connecting rod and become entrained in engine lubricating oil if the connecting rod is shot peened prior to laser peening. These advantages further include imparting compressive residual stress at specific locations and greater depths on the connecting rods beneficial to fatigue performance as compared to processes such as shot peening. Such compressive residual stresses are relatively higher than those achievable using shot peening. These advantages yet also include the ability to laser peen localized regions reducing the need to mask features that are not to be treated. These advantages yet further include the ability to machine and form threads prior to laser peening without the need to mask during the laser peening process.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A method of laser peening a connecting rod for a vehicle, comprising:
applying a clear coating on a first target surface and a second target surface of a connecting rod, wherein the connecting rod defines a pin opening at a first end and a cylindrical bore at a second end;
impinging the first target surface in a localized area between the pin opening and the cylindrical bore with a first plurality of pulses of a first pulsed laser beam;
impinging the second target surface in the localized area with a second plurality of pulses of a second pulsed laser beam, wherein the second target surface opposes the first target surface and the first plurality of pulses and the second plurality of pulses are emitted at the same time; and
forming a compressive residual stress to the first target surface and the second target surface at a depth of up to 0.75 millimeters.

2. The method of claim 1, further comprising: applying water as the clear coating.

3. The method of claim 2, further comprising: applying an overlay to the first target surface and the second target surface prior to applying the water, wherein the overlay is opaque to the first pulsed laser beam and the second pulsed laser beam.

4. The method of claim 3, wherein applying the overlay includes applying black paint.

5. The method of claim 3, further comprising impinging a first center axis of the first pulsed laser beam perpendicular to the first target surface; and impinging a second center axis of the second pulsed laser beam perpendicular to the second target surface.

6. The method of claim 5, wherein the first center axis and the second center axis are coaxial.

7. The method of claim 6, wherein the first center axis and the second center axis are offset along a length of the connecting rod.

8. The method of claim 3, further comprising impinging a first center axis of the first pulsed laser beam at an angle in the range of greater than 0 degrees to 30 degrees from perpendicular to the first target surface; and impinging a second center axis of the second pulsed laser beam at an angle in the range of greater than 0 degrees to 30 degrees from perpendicular to the second target surface.

9. The method of claim 8, wherein the first center axis and second center axis are coaxial.

10. The method of claim 9, wherein the first center axis is at an angle up to 10 degrees from the second center axis.

11. The method of claim 3, wherein a pulse of the first pulsed laser beam exhibits a first spot area on the first target surface and a plurality of the first spot areas of a plurality of the pulses of the pulsed laser beam overlap in the range of between 30 percent and 40 percent of the total spot area of the plurality of the spots.

12. The method of claim 3, further comprising impinging the first target surface with a third pulsed laser beam; and impinging the second target surface with a fourth pulsed laser beam.

13. The method of claim 1, further comprising machining at least one of a side slot and fastener threads in the connecting rod prior to impinging the first and second target surfaces with the first pulsed laser beam and second pulsed laser beam.

14. The method of claim 1, further comprising modeling the connecting rod and performing stress simulations to determine the localized area to impinge the connecting rod with the first plurality of pulses of the first pulsed laser beam and the second plurality of pulses of the second pulsed laser beam.

15. A method of cold working a connecting rod for a vehicle, comprising emitting from at least one laser source a first plurality of pulses of a first pulsed laser beam and a second plurality of pulses of a second pulsed laser beam;
impinging a first target surface in a localized area of a connecting rod including a clear coating with the first plurality of pulses, wherein the connecting rod defines a pin opening at a first end and a cylindrical bore at a second end and the localized area is between the pin opening and the cylindrical bore;
impinging a second target surface of the connecting rod including the clear coating with the second plurality of pulses, wherein the second target surface opposes the first target surface and the pulses of the first pulsed laser beam and the second pulsed laser beam are emitted at the same time;
evaporating a portion of the first target surface and generating a first plasma and evaporating a portion of the second target surface and generating a second plasma;
trapping the first plasma between the clear coating and the first target surface and trapping the second plasma between the clear coating and the second target surface;
expanding the first plasma and creating a first shockwave and expanding the second plasma and the second shockwave; and
forming a first compressive residual stress at the first target surface in the range of 500 Megapascals (MPa) to 1000 MPa, and a second compressive residual stress at the second target surface in the range of 500 Megapascals (MPa) to 1000 MPa, wherein the first and second compressive residual stresses are at a depth of up to 0.75 millimeters.

16. The method of claim 15, wherein the clear coating includes a layer of water.

17. The method of claim 16, wherein evaporating a portion of the first target surface includes evaporating a portion of an overlay on the first target surface; and evaporating a portion of the second target surface includes evaporating a portion of the overlay on the second target surface.

18. The method of claim 17, wherein the overlay comprises black paint.

19. The method of claim 16, wherein a first center axis of the first pulsed laser beam impinges the first target surface at an angle in the range of than 0 degrees to 30 degrees from perpendicular to the first target surface; and a second center axis of the second pulsed laser beam impinges the second target surface at an angle in the range of 0 degrees to 30 degrees from perpendicular to the second target surface.

20. A connecting rod for a vehicle, comprising:
a connecting rod defining a pin opening at a first end and a cylindrical bore at a second end; and
an overlay present on a surface of the connecting rod; and
a localized area between the pin opening and the cylindrical bore, wherein a portion of the overlay is removed in the localized area and wherein the localized area exhibits compressive residual stresses in the range of 500 Megapascals (MPa) to 1000 MPa at a depth of up to 0.75 millimeters.
